(19) United States
(12) Patent Application Publication
(10) Pub. No.: US 2002/0142271 A1
(43) Pub. Date: Oct. 3, 2002

(54) Visual learning aid system and method

(76) Inventor: Kazuko Curtin, Austin, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 09/791,084

(22) Filed: Feb. 22, 2001

(51) Int. Cl. G09B 19/00; G09B 1/00

(52) U.S. Cl. 434/167

(57) ABSTRACT

The present invention provides a visual learning aid system, which includes at least one target picture card having a graphical representation of a target subject matter depicted thereon, and at least one word cue card detachably affixable to the target picture card, the at least one word cue card having at least one word describing at least one aspect of the target subject matter printed thereon. The present invention further includes a teaching method utilizing the visual learning aid of the present invention.

### TECHNICAL FIELD OF THE INVENTION

This invention relates to teaching aids and methods, and more particularly, to a visual learning aid system and teaching method.

### BACKGROUND OF THE INVENTION

For the parents and teachers of many autistic children, conventional teaching methods such as Applied Behavior Analysis (ABA) are disappointing which fail to elicit progress commonly seen other children affected to a lesser degree. These non-reachable children remain cloistered in their own worlds with distant stares and self-stimulate with repetitive stemming movements and sounds. They do not communicate with the outside world; most do not speak. Experts label these children as “low functioning” with a despairing prognosis. These experts often advise the parents of low functioning children to institutionalize them and forget about them. These experts have nothing to offer. As far as they know, there is no cure for autism and there is no known teaching method that can bridge the chasm to reach these non-communicative children. As a result, many parents give up, leaving behind a legacy of unfulfilled expectations and broken hearts.

### SUMMARY OF THE INVENTION

It may be seen that there is a previously unsatisfied need to provide a way to reach and teach children who are primarily visual learners and especially those autistic children who have been previously unable to speak or have been unreachable with conventional teaching tools and teaching methods.

In accordance with an embodiment of the present invention, a visual learning aid system includes at least one target picture card having a graphical representation of a target subject matter depicted thereon, and at least one word cue card detachably affixable to the target picture card, the at least one word cue card having at least one word describing at least one aspect of the target subject matter printed thereon.

In accordance with another embodiment of the present invention, a visual learning card system includes a plurality of target picture cards having graphical representations of target subject matters depicted thereon, and a plurality of word cue cards detachably affixable to the target picture cards by a fabric grip material. The plurality of word cue cards each has at least one word describing at least one aspect of the target subject matters printed thereon.

In accordance with yet another embodiment of the present invention, a teaching method includes the steps of presenting to a student at least one target picture card having a graphical representation of a target subject matter depicted thereon. The target picture card additionally has at least one word cue card detachably affixed thereto. The at least one word cue card has at least one word describing at least one aspect of the target subject matter printed thereon. The student is prompted to perform a physical activity with the at least one target picture card with a specific target subject matter printed thereon, first with the word cue card affixed to the target picture card, then with the word cue card removed from the target picture card.

The advantage of the present invention is that despite its simple construction and similarity to conventional flash cards, the derived benefit exceeds all expectations and generates surprising results in visual learners and non-speaking autistic students. The communication barriers between the student and the teachers when conventional teaching tools and methods were used are torn down. Through the use of the card system of the present invention, previously non-communicative students become expressive physically and verbally, and become capable to receive and process auditory information because the information is organized in a way that is receptive to the visually-oriented student.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a graphical representation of an embodiment of a target picture card and a word cue card directed to teaching object identification according to the teachings of the present invention;

FIG. 2 is a graphical representation of another embodiment of three target picture cards and respective word cue cards directed to teaching relative comparison according to the teachings of the present invention;

FIG. 3 is a graphical representation of yet another embodiment of a target picture card, a word cue card, a visual prompt, and an indicia cue card directed to teaching relative comparison according to the teachings of the present invention;

FIG. 4 is a graphical representation of yet another embodiment of a target picture card and a plurality of word cue cards directed to teaching object identification and relative comparison according to the teachings of the present invention; and

FIG. 5 is a graphical representation of another embodiment of a plurality of target picture cards and a plurality of word cue cards directed to teaching relative comparison according to the teachings of the present invention.

### DETAILED DESCRIPTION OF THE DRAWINGS

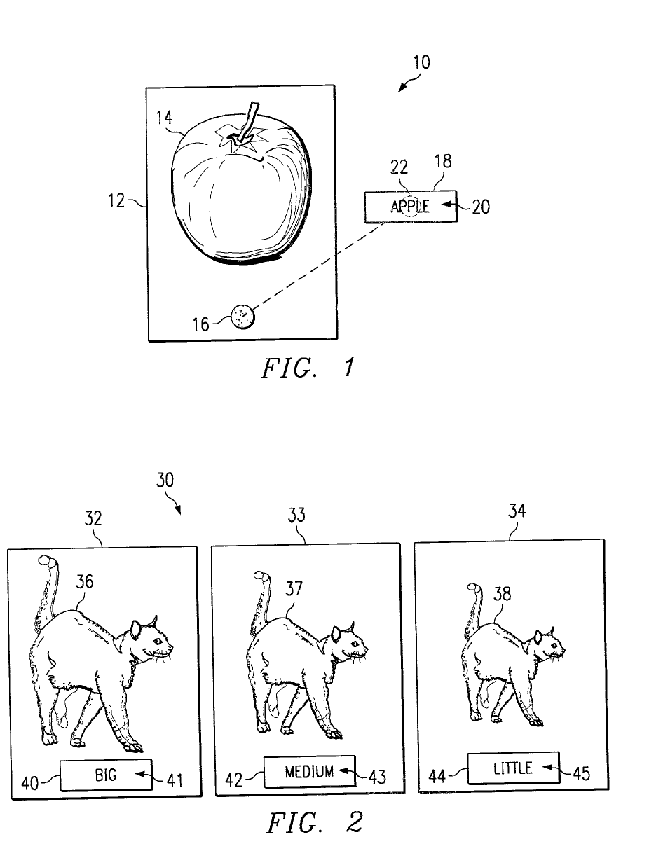

The preferred embodiment of the present invention and its advantages are best understood by referring to FIGS. 1 through 5 of the drawings, like numerals being used for like and corresponding parts of the various drawings.

It will be seen that the present invention includes a system and method using a plurality of cards that are designed to take advantage the strong visual learning capabilities of certain individuals in order to teach object identification (including color identification, person identification, emotion identification, occupation identification, and activity identification), relative comparisons, and absolute comparisons. It is known that persons diagnosed with pervasive developmental disorder (PDD) and autism perceive, express and process information in their surroundings primarily in a visual manner rather than in a verbal or auditory manner. The present invention has shown unexpected promise in reaching and teaching those individuals identified as low functioning and for whom traditional teaching methods such as the Applied Behavior Analysis (ABA) method have been unsuccessful. The system and method of the present invention may be thought of as a bridge that spans the chasm to reach the low functioning individuals so that more traditional methods can additionally be used. It is almost akin to turning on a light bulb inside the PDD or autistic brain so that learning can begin.

FIG. 1 is a graphical representation of an embodiment of a visual learning aid system 10 including a target picture card 12 and a word cue card 18 directed to teaching object identification according to the teachings of the present invention. Target picture card 12 has depicted thereon a graphical representation or photograph of an object, such as an apple 14 as shown. The graphical representation or photograph may be color or black and white, and may be simple or complex. For example, the pictorial depiction may be a simple line drawing or a realistic high quality photograph. Target picture card is preferably of a suitable thickness so that it is not easily bent or torn. Conventional lamination techniques may be used to protect target picture card 12 and to make it more rigid and waterproof. Word cue card 14 has printed thereon the word(s) or name 20 of the object shown on target picture card 12. As shown in FIG. 1, word cue card 14 has the word “APPLE” printed on one side. On the other side of word cue card 14 is an adhesive such as a small segment of a hook or loop tape 22, which is removably affixable to a segment of hook or loop tape or a similar fabric grip material 16 secured at an appropriate location on target picture card 12. The mechanism for fastening word cue card 18 to target picture card 12 can be any suitable adhesive or fastener which enable word cue card 18 to be easily and repeatably affixed to target picture card 12 and also easily and repeatably removed and reused. Hook and loop fasteners are manufactured and sold under the trademark VELCRO by 3M. Other examples of possibly suitable fasteners include a removable plastic adhesive made by SAUNDERS and marketed under the name HOLDIT, and a reusable mounting adhesive made by ROSS and marketed under the name TAC'N STICK.

The present invention provides a visual learning system that has been proven to be a more effective teaching tool than the conventional flash cards where the cue word is printed directly on the same surface of the card bearing the picture of the target object. Because the autistic students are typically visual learners, their first language is the visually processed written language rather than language acquired through the auditory and oral senses. The card system and teaching method of the present invention utilizes this characteristic of the autistic children and uses the written words as cues for the target objects, rather than the other way around as flash cards are commonly used. To the autistic student, the card system of the present invention functions differently from conventional flash cards. Autistic persons tend to see and focus on minute details rather than the big picture. With conventional flash cards, an autistic student sees the shiny smooth surface of the apple shown on the card, the brown short stem rising out of the top of the apple, the small green textured leaf on the stem, the shape of the apple, and the length and angles of the line segments that form the letters. With the conventional flash cards, these students have difficulty associating the picture of the object to the line segments that form the word as the name of the object. Students previously identified as “low-functioning” when taught using traditional methods such as ABA, may begin to associate the cue words on the cue word cards to the objects on the target picture cards, and eventually able to say the cue word, write the cue word, and type the cue word on a keyboard.

Further, the preferred use of hook and loop fasteners in the present invention may provide an unexpected benefit over other fasteners, namely the loud audible noise when the word cue card is removed from the target picture card as a an added dimension for learning reinforcement. Because the hook and loop fabric has a certain thickness, the word cue card, when affixed to the target picture card, is slightly elevated off the surface of the target picture card, thus providing a three-dimensional visual look and feel. It is contemplated by the present invention that this elevation of the cue word is beneficial for directing and focusing the student's attention on the word as separate from the object depicted in the picture on the target picture card. This property of the present invention, along with the ability to easily remove the cue word from the object in the picture and easily associate (attach) the cue word to the object in the picture, provides a previously unexpected result for those students who rely heavily on vision as the key receptor of information from the outside world, such as persons with autism.

The concept behind object identification described above may additionally be used for color identification. For example, the target picture card is of a certain color to be named, and the word cue card contains the name of the color. For person identification, the target picture card may show a graphical representation of a person in the student's life, and the word cue card bearing the name of the person (Chris and Nicole, for example) or the role that the person plays in the student's life (Mommy and Daddy, for example). Emotion identification may be another aspect that can be taught by the target picture card and word cue cards. For example, a picture or drawing of a person's face showing a particular emotion (happiness, sadness, etc.) can be matched to a word cue card having the name of the emotion. The object identified by the target picture cards and cue word cards may be body parts, such as “my nose”, “my head”, “my face”, “my elbow”, etc. The target picture card and word cue card system may also be used to teach occupation identification, using pictures of persons with identifiable occupations (fireman, fisherman, policeman, etc.). Activity identification may be yet another skill taught by the present invention, using graphical representations or photographs of the student performing various activities, such as brushing teeth, sleeping, eating, brushing hair, putting on a shirt, playing ball, etc.

Object identification cards of the present invention can be used a number of ways to gradually introduce the target concept shown in the table below.

| | | | Pronunciation | | | | | | | | | | |
|---|---|---|---|---|---|---|---|---|---|---|---|---|---|
| | Receptive | | A: Very good | | | Read | | Write | | Draw | | Pretend | |
| | Point to . . . | Expressive | B: Good | | | A: P + W | | A: Picture | | A: Picture | | A: Sounds | |
| Labels | Give me . . . | What is it? | C: Need to work | | | B: word only | | B: Verbal | | B: Verbal | | B: S + motions | |
| Occupations | Touch . . . | What animal? | A | B | C | A | B | A | B | A | B | A | B |

fireman
doctor
policeman
nurse
businessman
fisherman
mailman
chef
judge
gardner
cleaner
waiter
carpenter
constructor

The target picture card with the word cue card bearing the correct name of the target object affixed thereto can be shown to the student in a receptive exercise. The teacher may provide a verbal prompt of “Point to the apple,” or “Touch the apple.” When the student is able to indicate an understanding of the word “apple” on the word cue card associated with the picture of the apple on the target picture card, the teacher may show the apple target picture card along with a number of other target picture cards and prompt the student to identify the card bearing the picture of the apple. The teacher may also remove the cue word card and ask the student to match the correct cue word card to the correct target picture card. These exercises are repeated until the student shows a good grasp of the association of the word “apple” on the cue word card to the picture of the apple on the target picture card. The next exercise, the expressive exercise, is for the teacher to prompt the student to utter the word “apple”when the student is presented with the target picture card with the word cue card. The student's pronunciation of the word is evaluated. The student is also encouraged to read the cue word by showing the student the cue word card with the target picture card, and then just the cue word card without the target picture card. The student is also asked to write the cue word with a picture prompt by showing the target picture card, and then with a verbal prompt only. The student is also asked to draw the target object while showing the target picture card, and then with a verbal prompt only. For certain appropriate target objects, a pretend exercise may be performed by asking the student to make the sounds associated with the target object, and then for the sounds and motions associated with the object. An additional exercise is prompting the student to type the cue word by showing the target picture card, and then with only a verbal prompt. By mastering these various exercises with the cue word, the student becomes thoroughly familiar with the cue word and eventually acquires capabilities independent of the target picture card and cue word card.

FIG. 2 is a graphical representation of another embodiment of a set 30 of multiple target picture cards 32-34 and respective word cue cards directed to teaching relative comparison according to the teachings of the present invention. Target picture cards 32-34 have pictures of a big cat 36, medium cat 37, and a little cat 38, relative to one another. Word cue card 40 for target picture card 32 bears the word “big” 41, word cue card 42 for target picture card 33 bears the word “medium” 43, and word cue card 34 for target picture card 34 bears the word “medium” 45. As described above, each word cue card has a fastener on the back side which enables the word cue card to be detachably affixed to the target picture card. Using target picture cards and cue word cards such as shown in FIG. 2, relative comparative properties of objects may be taught. For example, size, weight, and length are suitable concepts. For each set of cards teaching a certain concept, either the same object or different object may be shown on the target picture cards for varying degrees of difficulty.

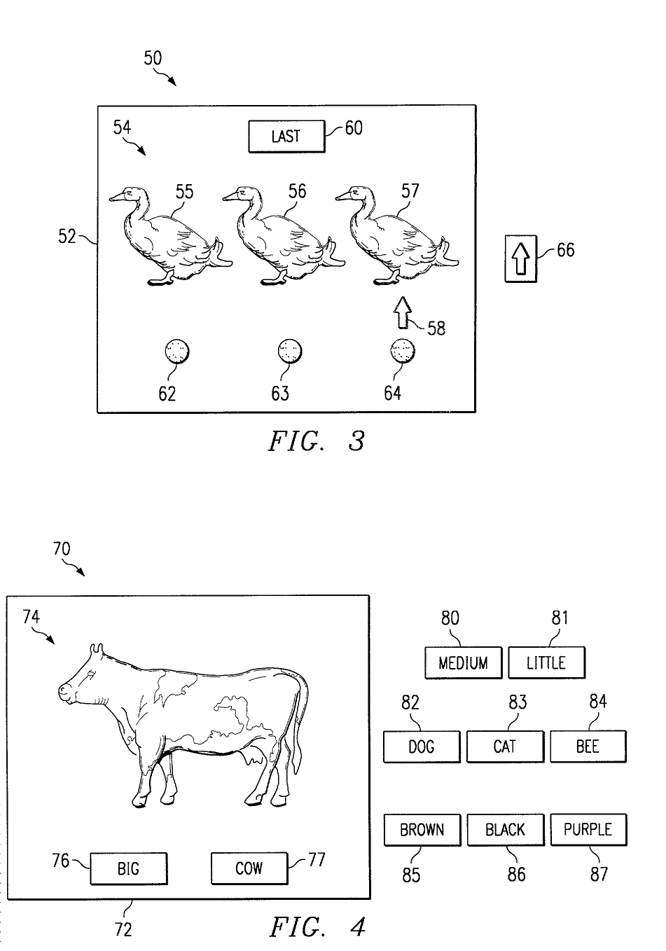

FIG. 3 is a graphical representation of yet another embodiment 50 of a target picture card 52 and a word cue card 60 using a visual prompt 58 and an indicia cue card 66 directed to teaching relative comparison according to the teachings of the present invention. Embodiment 50 teaches the concept of order in a series of objects 54, such as the last duck 57 in a line up of three ducks 55-57 shown on target picture card 52. To draw the student's attention to the correct object, a visual prompt 58 is also printed on the surface of target picture card 52. Preferably, visual prompt 58 is shown as an arrow pointing to the last duck 57 and positioned directly below it. Three fastening positions 62-64 are also provided on target picture card 52 below each of the ducks 55-57. The student is first shown the target picture card with indicia cue card 66 positioned below duck 57 and affixed thereto at fastening position 64. The teacher may remove indicia cue card 66 and replace it at the correct position several times and point to visual prompt 58 and the last duck 57. The students is then asked to remove and replace the indicia cue card several times with the teacher providing encouragement and appropriate verbal prompts. Eventually, the student is able to place the indicia cue card 66 at the correct position to point to the last duck in the series. Other concepts may be taught by this same system, such as first in a series, second in a series, third in a series, etc.

FIG. 4 is a graphical representation of yet another embodiment 70 of a target picture card 72 and a plurality of word cue cards 76 and 77 directed to teaching object identification and relative comparison according to the teachings of the present invention. Target picture card 72 has printed thereon a drawing or photograph of a target object, such as a cow 74. Target picture card 72 may receive at least two word cue cards, such as “big” 76 and “cow” 77. Other cue word cards 80-87 form a pool of available words that the student may select to identify the target object and a property associated with the target object. Some of the words on word cue cards bear words that may be correctly used to identify the target object on target picture card 72, such as “brown” 85, and others which may be incorrect, such as “purple” 87, “dog” 82, “cat” 83, and “bee” 84.

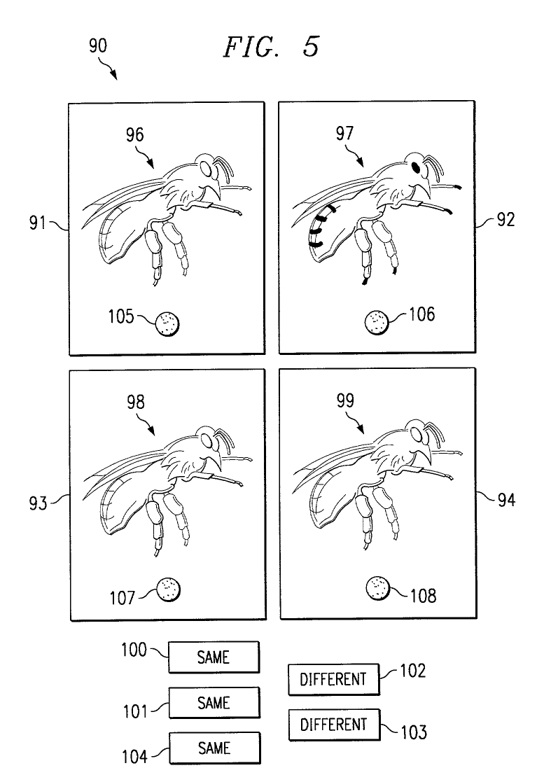

FIG. 5 is a graphical representation of another embodiment 90 of a plurality of target picture cards 91-94 and a plurality of word cue cards 100-104 directed to teaching relative comparison according to the teachings of the present invention. As shown in FIG. 5, the teaching concept is same and different. Target picture cards 91, 93, and 94 show bees 96, 98 and 99 with the same pattern on its body, and target picture card 92 shows a bee 97 with a different body pattern. Fasteners 105-108 are placed at appropriate locations on target picture cards 91-94 to receive the word cue cards. Word cue cards 100-104 bear the words “same” and “different”. The students are first shown the target picture cards with the correct word cue cards affixed. The teacher may point to the word “same” and pronounce it and also the word “different” and pronounce it. The teacher may point to the feature that is different or same between the target objects. After the student has been properly familiarized with the concept, the student may then be shown the target picture cards without the cue word cards attached, and encouraged to fasten the correct word cue card to the correct target picture card.

It may be seen that the present invention, though simple in construction and similar to conventional flash cards that typically have a picture and a word name printed on each card, unexpected and surprising advantages are produced by the design and construction of the word cue card separate and attachable to the target picture card. The present invention provides a visual learning system that has been proven on at least one student to be more effective than the conventional flash cards. The ability for the teacher and student to easily disassociate (remove) the cue word from the object in the picture, and easily associate (attach) the cue word to the object in the picture, provides a previously unexpected result for those students who rely heavily on vision as the key receptor and processor of information. The card system and teaching method of the present invention utilizes the written word as a cue for the target object, rather than the other way around as flash cards are commonly used (for example, teaching young children the written word by showing the picture of the object). Autistic students previously identified as “low-functioning” when taught using traditional methods such as ABA or with conventional flash cards, may begin to associate the cue words on the cue word cards to the objects on the target picture cards, and eventually be able to say the cue word, write the cue word, and type the cue word on a keyboard with picture prompts and verbal prompts. The use of the card system and teaching methods of the present invention allows teachers to reach the low-functioning student and thus bridge the previously unbreachable gap between conventional methods and the student.

While the invention has been particularly shown and described by the foregoing detailed description, it will be understood by those skilled in the art that various changes, alterations, modifications, mutations and derivations in form and detail may be made without departing from the spirit and scope of the invention.

What is claimed is:

1. A visual learning aid system, comprising:
at least one target picture card having a graphical representation of a target subject matter depicted thereon; and
at least one word cue card detachably affixable to the target picture card, the at least one word cue card having at least one word describing at least one aspect of the target subject matter printed thereon.

2. The system, as set forth in claim 1, wherein the target subject matter is colors, and the at least one word cue card has a color name of a color shown on the at least one target picture card.

3. The system, as set forth in claim 1, wherein the target subject matter is objects, and the at least one word cue card has a name of an object shown on the at least one target picture card.

4. The system, as set forth in claim 1, wherein the target subject matter is persons, and the at least one word cue card has a name or role of a person shown on the at least one target picture card.

5. The system, as set forth in claim 1, wherein the target subject matter is occupations, and the at least one word cue card has a name of an occupation of a person shown on the at least one target picture card.

6. The system, as set forth in claim 1, wherein the target subject matter is activities, and the at least one word cue card has a name of an activity being performed by a person shown on the at least one target picture card.

7. The system, as set forth in claim 1, wherein the target subject matter is animals, and the at least one word cue card has a name of an animal shown on the at least one target picture card.

8. The system, as set forth in claim 1, wherein the target subject matter is emotions, and the at least one word cue card has a name of an emotion expressed by a person shown on the at least one target picture card.

9. The system, as set forth in claim 1, wherein the target subject matter is size comparison, and the at least one word cue card includes words indicative of relative size comparisons of objects shown on the at least one target picture card.

10. The system, as set forth in claim 1, wherein the target subject matter is length comparison, and the at least one word cue card includes words indicative of relative length comparisons of objects shown on the at least one target picture card.

11. The system, as set forth in claim 1, wherein the target subject matter is order in a series, and the at least one word cue card includes words indicative of order in a series of objects shown on the at least one target picture card.

12. The system, as set forth in claim 1, wherein the target subject matter is a relative comparison of a property of a target object, and the at least one word cue card includes words indicative of relative comparisons of the target objects shown on the at least one target picture card.

13. The system, as set forth in claim 1, wherein the at least one word cue card is detachably affixable to the at least one target picture card by a repeatably attachable and detachable fastener.

14. The system, as set forth in claim 1, wherein the at least one word cue card is detachably affixable to the at least one target picture card by segments of a fabric grip material.

15. The system, as set forth in claim 1, wherein the at least one word cue card is detachably affixable to the at least one target picture card by segments of hook and loop materials.

16. A visual learning card system, comprising:
a plurality of target picture cards having graphical representations of target subject matters depicted thereon; and
a plurality of word cue cards detachably affixable to the target picture cards with fabric grip material, the plurality of word cue cards each having at least one word describing at least one aspect of the target subject matters printed thereon.

17. The system, as set forth in claim 16, wherein the target subject matters include colors, and the plurality of word cue cards have color names of colors shown on the plurality of target picture cards.

18. The system, as set forth in claim 16, wherein the target subject matters include objects, and the plurality of word cue cards have names of the objects shown on the plurality of target picture cards.

19. The system, as set forth in claim 16, wherein the target subject matters include persons, and the plurality of word cue cards have names or roles of persons shown on the plurality of target picture cards.

20. The system, as set forth in claim 16, wherein the target subject matters include occupations, and the plurality of word cue cards have names of occupations of persons shown on the plurality of target picture cards.

21. The system, as set forth in claim 16, wherein the target subject matters include activities, and the plurality of word cue cards have names of activities being performed by persons shown on the plurality of target picture cards.

22. The system, as set forth in claim 16, wherein the target subject matters include animals, and the plurality of word cue cards have names of animals shown on the plurality of target picture cards.

23. The system, as set forth in claim 16, wherein the target subject matters include emotions, and the plurality of word cue cards have names of emotions expressed by persons shown on the plurality of target picture cards.

24. The system, as set forth in claim 16, wherein the target subject matters include size comparisons, and the plurality of word cue cards include words indicative of relative size comparisons of objects shown on the plurality of target picture cards.

25. The system, as set forth in claim 16, wherein the target subject matters include length comparisons, and the plurality of word cue cards include words indicative of relative length comparisons of objects shown on the plurality of target picture cards.

26. The system, as set forth in claim 16, wherein the target subject matters include order in a series of objects, and the plurality of word cue cards include words indicative of order in a series of objects shown on the plurality of target picture cards.

27. The system, as set forth in claim 16, wherein the target subject matters include relative comparisons of properties of target objects, and the plurality of word cue cards include words indicative of relative comparisons of the target objects shown on the plurality of target picture cards.

28. The system, as set forth in claim 16, wherein the plurality of word cue cards are detachably affixable to the plurality of target picture cards by a repeatably attachable and detachable fastener.

29. The system, as set forth in claim 16, wherein the plurality of word cue cards are detachably affixable to and detachable from the plurality of target picture cards by an adhesive.

30. The system, as set forth in claim 16, wherein the plurality of word cue cards are detachably affixable to and detachable from the plurality of target picture cards by segments of hook and loop materials.

31. A teaching method, comprising:
presenting to a student at least one target picture card having a graphical representation of a target subject matter depicted thereon, the target picture card additionally having at least one word cue card detachably affixed thereto, the at least one word cue card having at least one word describing at least one aspect of the target subject matter printed thereon; and
prompting the student to perform a physical activity with the at least one target picture card with a specific target subject matter printed thereon, first with the word cue card affixed to the target picture card, then with the word cue card removed from the target picture card.

32. The teaching method, as set forth in claim 31, further comprising prompting the student to verbally express the word printed on the word cue card.

33. The teaching method, as set forth in claim 31, further comprising prompting the student to read the word printed on the word cue card, first with the word cue card affixed to the target picture card, then with the word cue card removed from the target picture card.

34. The teaching method, as set forth in claim 31, further comprising prompting the student to write the word printed on the word cue card, first with the word cue card only, then with a verbal prompt only.

35. The teaching method, as set forth in claim 31, further comprising prompting the student to draw a picture of the target subject matter, first with the target picture card only, then with a verbal prompt only.

36. The teaching method, as set forth in claim 31, further comprising prompting the student to type the word printed on the word cue card using a keyboard, first with the target picture card only, then with a verbal prompt only.

37. The teaching method, as set forth in claim 31, wherein prompting the student to perform a physical activity comprises prompting the student to point to the target picture card having the target subject matter.

38. The teaching method, as set forth in claim 31, wherein prompting the student to perform a physical activity comprises prompting the student to identify the target picture card having the prompted target subject matter from among a plurality of target picture cards.

39. The teaching method, as set forth in claim 31, wherein prompting the student to perform a physical activity comprises prompting the student to attach the correct word cue card to the target picture card having the prompted target subject matter.

40. The teaching method, as set forth in claim 31, wherein prompting the student to perform a physical activity comprises prompting the student to attach the correct word cue card to a correct location on the target picture card having the prompted target subject matter.

41. The teaching method, as set forth in claim 31, wherein presenting to the student at least one target picture card comprises presenting a target picture card having the target subject matter of color, and the at least one word cue card has a color name of a color shown on the at least one target picture card.

42. The teaching method, as set forth in claim 31, wherein presenting to the student at least one target picture card comprises presenting a target picture card having the target subject matter of objects, and the at least one word cue card has a name of an object shown on the at least one target picture card.

43. The teaching method, as set forth in claim 31, wherein presenting to the student at least one target picture card comprises presenting a target picture card having the target subject matter of persons, and the at least one word cue card has a name or a role of a person shown on the at least one target picture card.

44. The teaching method, as set forth in claim 31, wherein presenting to the student at least one target picture card comprises presenting a target picture card having the target subject matter of activities, and the at least one word cue card has a name of an activity shown on the at least one target picture card.

45. The teaching method, as set forth in claim 31, wherein presenting to the student at least one target picture card comprises presenting a target picture card having the target subject matter of animals, and the at least one word cue card has a name of an animal shown on the at least one target picture card.

46. The teaching method, as set forth in claim 31, wherein presenting to the student at least one target picture card comprises presenting a target picture card having the target subject matter of emotions, and the at least one word cue card has a name of an emotion shown on the at least one target picture card.

47. The teaching method, as set forth in claim 31, wherein presenting to the student at least one target picture card comprises presenting a target picture card having the target subject matter of size comparison, and the at least one word cue card includes words indicative of relative size comparisons of objects shown on the at least one target picture card.

48. The teaching method, as set forth in claim 31, wherein presenting to the student at least one target picture card comprises presenting a target picture card having the target subject matter of length comparison, and the at least one word cue card includes words indicative of relative length comparisons of objects shown on the at least one target picture card.

49. The teaching method, as set forth in claim 31, wherein presenting to the student at least one target picture card comprises presenting a target picture card having the target subject matter of order in a series, and the at least one word cue card includes words indicative of order in a series of objects shown on the at least one target picture card.

50. The teaching method, as set forth in claim 31, wherein presenting to the student at least one target picture card comprises presenting a target picture card having the target subject matter of a property of a target object, and the at least one word cue card includes words indicative of relative comparisons of the property of the target objects shown on the at least one target picture card.
